(19) United States
(12) Patent Application Publication
(10) Pub. No.: US 2021/0247765 A1
(43) Pub. Date: Aug. 12, 2021

(54) INFORMATION PROCESSING APPARATUS, INFORMATION PROCESSING METHOD, AND VEHICLE

(71) Applicant: TOYOTA JIDOSHA KABUSHIKI KAISHA, Toyota-shi (JP)

(72) Inventors: Katsuhisa YOSHIKAWA, Toyota-shi (JP); Yuji SUZUKI, Kariya-shi (JP); Keita YAMAZAKI, Nisshin-shi (JP); Kei MATSUMOTO, Toyota-shi (JP); Hiroyuki ITO, Nagoya-shi (JP); Takashi OGAWA, Toyota-shi (JP); Yukiya SUGIYAMA, Toyota-shi (JP); Masaru ANDO, Seto-shi (JP); Tae SUGIMURA, Miyoshi-shi (JP); Mitsuyoshi OHNO, Miyoshi-shi (JP); Daiki KUBO, Toyota-shi (JP); Yosuke NOZAKI, Toyota-shi (JP); Tsukasa NAKANISHI, Nagoya-shi (JP); Hironori AOYAMA, Toyota-shi (JP); Seiji YOGO, Nagoya-shi (JP); Yasuhiro KOBATAKE, Nagoya-shi (JP); Ryo SATO, Nisshin-shi (JP); Sayaka NINOYUU, Toyota-shi (JP); Yasushi FUJIWARA, Toyota-shi (JP); Azusa NAKAGAME, Kariya-shi (JP); Takeshi YAMADA, Anjo-shi (JP); Erina TOYAMA, Toyota-shi (JP)

(73) Assignee: TOYOTA JIDOSHA KABUSHIKI KAISHA, Toyota-shi (JP)

(21) Appl. No.: 17/168,793

(22) Filed: Feb. 5, 2021

(30) Foreign Application Priority Data
Feb. 6, 2020 (JP) 2020-018868

(51) Int. Cl. G05D 1/00; G05B 19/4155; G05D 1/02; B62B 3/10

(52) U.S. Cl. CPC G05D 1/0088; G05B 19/4155; G05D 1/0212; B62B 2202/70; G05B 2219/45017; G05D 2201/0201; B62B 3/10

(57) ABSTRACT

An information processing apparatus disclosed has a controller equipped with at least one processor. The controller is configured to execute the processing of; when a vehicle body unit on which a cultivation field for cultivating a crop is mounted is laid at a first place, determining a time to remove defined as a time to remove the vehicle body unit from the first place to a second place other than the first place; and sending a transportation command to a chassis unit configured to be capable of travelling autonomously and being coupled to and decoupled from any vehicle body unit in accordance with the time to remove, the transportation command being a command to transport the vehicle body unit from the first place to the second place.

### CROSS REFERENCE TO RELATED APPLICATION

This application claims the benefit of Japanese Patent Application No. 2020-18868, filed on Feb. 6, 2020, which is hereby incorporated by reference herein in its entirety.

### BACKGROUND

### Technical Field

This disclosure relates to technologies pertaining to management of fields for cultivating crops.

### Description of the Related Art

There are known separable vehicles constructed by combining a plurality of separable units (see, for example, Patent Document 1 in the citation list below).

### CITATION LIST

### Patent Literature

Patent Literature 1: DE 10 2009 057 693

### SUMMARY

An object of this disclosure is to provide a technology that enables efficient management of fields for growing crops.

Disclosed herein is an information processing apparatus. The information processing apparatus comprises a controller equipped with at least one processor,

the controller configured to execute the processing of

when a vehicle body unit on which a cultivation field for cultivating a crop is mounted is laid at a first place, determining a time to remove defined as a time to remove the vehicle body unit from the first place to a second place other than the first place; and

sending a transportation command to a chassis unit configured to be capable of travelling autonomously and being coupled to and decoupled from any vehicle body unit in accordance with the time to remove, the transportation command being a command to transport the vehicle body unit from the first place to the second place.

Also disclosed herein is an information processing method. The information processing method comprises the following steps of processing executed by a computer:

when a vehicle body unit on which a cultivation field for cultivating a crop is mounted is laid at a first place, determining a time to remove defined as a time to remove the vehicle body unit from the first place to a second place other than the first place; and

sending a transportation command to a chassis unit configured to be capable of travelling autonomously and being coupled to and decoupled from any vehicle body unit in accordance with the time to remove, the transportation command being a command to transport the vehicle body unit from the first place to the second place.

Also disclosed herein is a vehicle. The vehicle comprises a controller equipped with at least one processor,

the controller configured to execute the processing of:

when a vehicle body unit on which a cultivation field for cultivating a crop is mounted is laid at a first place, determining a time to remove defined as a time to remove the vehicle body unit from the first place to a second place other than the first place; and

performing the operation of transporting the vehicle body unit from the first place to the second place in accordance with the time to remove.

Other modes of the technology disclosed herein include an information processing program configured to cause the computer to implement the above-described information processing method and a non-transitory storage medium in which this information processing program is stored in a computer-readable manner.

This disclosure can provide a technology that enables efficient management of a field for cultivating a crop.

### BRIEF DESCRIPTION OF THE DRAWINGS

FIG. 1 is a diagram illustrating the general configuration of a cultivation field management system.

FIG. 2 is a first diagram illustrating the general configuration of a separable vehicle.

FIG. 3 is a second diagram illustrating the general configuration of the separable vehicle.

FIG. 4 is a diagram illustrating the hardware configurations of a chassis unit, a vehicle body unit, and a server apparatus.

FIG. 5 is a block diagram illustrating an exemplary functional configuration of the chassis unit.

FIG. 6 is a block diagram illustrating an exemplary functional configuration of the server apparatus.

FIG. 7 illustrates an exemplary structure of a vehicle body information table.

FIG. 8 illustrates an exemplary structure of a potential place information table.

FIG. 9 illustrates an exemplary structure of a chassis information table.

FIG. 10 is a flow chart of a process executed by the server apparatus repeatedly at predetermined intervals.

### DESCRIPTION OF THE EMBODIMENTS

The technology disclosed herein is characterized by that separable a vehicle is used for management of a field for cultivating a crop (or cultivation field) to improve efficiency of crop cultivation and/or other operations.

If the location a field for cultivating a crop (or cultivation field) is fixed as with agricultural lands, the growth of the crop can be influenced by the environment around that location. Therefore, when the environment changes or is expected to change, it is necessary for a worker to go to the cultivation field to take some action. When harvesting and selling the crop cultivated in the cultivation field, it is necessary for a worker to go to the cultivation field to harvest the crop and transport it from the cultivation field to a place where it is to be sold. For the above reasons, it is difficult to manage cultivation fields efficiently.

The technology disclosed herein uses a separable vehicle for the purpose of management of a cultivation field. The separable vehicle is composed of a vehicle body unit on which a cultivation field is mounted and a chassis unit adapted to be coupled to and decoupled from the vehicle body unit and capable of travelling autonomously. While a crop is cultivated in the cultivation field, the vehicle body unit decoupled from the chassis unit is laid (in other words, left stationary) at a desired place.

While the crop is cultivated in the cultivation field, the vehicle body unit might be left coupled with the chassis unit. However, this prevents the effective use of the chassis unit while crop is cultivated. Moreover, this requires chassis units as many as vehicle body units on which cultivation fields are mounted, thereby requiring an increased cost of equipment. In contrast, if the vehicle body unit alone is left stationary with the chassis unit decoupled, one chassis unit can be used for a plurality of vehicle body units. This mode allows the chassis unit to be used efficiently during the cultivation of the crop and the cost of equipment to be reduced.

While the vehicle body unit is laid at a certain place (first place), a controller of an information processing apparatus determines the time to change the location of the vehicle body unit, namely the time to remove the vehicle body unit (along with the cultivation field), which will also be referred to as the “time to remove”. Then, the controller sends a transportation command to the chassis unit in accordance with the time to remove determined as above. The transportation command is a command to transport the vehicle body unit laid at the first place to a second place other than the first place.

After receiving the transportation command, the chassis unit operates pursuant to the transportation command to retrieve the vehicle body unit from the first place, transport the retrieved vehicle body unit from the first place to the second place, and set the vehicle body unit stationary at the second place. In this way, the location of the cultivation field can be changed automatically. This saves the worker's effort of travelling when doing various works.

The transportation command may include, for example, the following four commands:
first command: a command to cause the chassis unit to travel to the first place
second command: a command to couple the chassis unit to the vehicle body unit at the first place
third command: a command to cause the chassis unit to travel from the first place to the second place
fourth command: a command to decouple (or separate) the chassis unit from the vehicle body unit at the second place.

After receiving the transportation command, the chassis unit firstly travels to the first place by autonomous driving pursuant to the first command. When arriving at the first place, the chassis unit operates pursuant to the second command to couple itself to the vehicle body unit. The operation of coupling the chassis unit to the vehicle body unit may be carried out by an external apparatus provided with a heavy machine, such as a lift or a crane. Alternatively, the operation of coupling the chassis unit to the vehicle body unit may be carried out by an apparatus provided on the chassis unit or the vehicle body unit. After the chassis unit and the vehicle body unit are coupled together in this way, the chassis unit travels by autonomous driving pursuant to the third command to transport the vehicle body unit from the first place to the second place. When arriving at the second place, the chassis unit operates pursuant to the fourth command to decouple itself from the vehicle body unit. Thus, the vehicle body unit is laid at the second place. The operation of decoupling the chassis unit from the vehicle body unit may be carried out by either an external apparatus like that described above or an apparatus provided on the chassis unit or the vehicle body unit. As described above, the operation of the chassis unit pursuant to the first to fourth commands can change the location of the cultivation field automatically from the first place to the second place.

The aforementioned time to remove may be determined as the time when the environment around the first place changes to an environment that is not suitable for the cultivation of the crop in the field. In that case, the second place may be a place having an environment suitable for the cultivation of the crop in the field. Thus, the cultivation field can be removed automatically from the first place to the second place, which is suitable for cultivation of the crop, in accordance with the time when the environment around the first place changes. Therefore, the cultivation field can be placed in an environment suitable for the cultivation of the crop, thereby saving the worker's effort of taking countermeasures against the environment that is not suitable for the cultivation of the crop.

The environment of the first place may include, for example, the weather at the first place or the occurrence and absence of a disaster around the first place. Information about the weather at the first place or information about the occurrence and absence of a disaster around the first place may be obtained using a weather information service or a disaster information service provided on the Internet.

Alternatively, the time to remove may be a time to harvest the crop in the cultivation field. In that case the second place may be a place where the operation of harvesting the crop in the cultivation field is performed, which will also be referred to as the “place of harvest”. Thus, the cultivation field can be removed automatically from the first place (e.g. a place suitable for the cultivation of the crop) to the second place (i.e. the place of harvest) in accordance with the time to harvest the crop. This can save the worker's effort of going to the first place to perform the operation of harvesting the crop. Information about the time to harvest the crop and information about the place of harvest may be provided by the user of the vehicle body unit (or the cultivation field). The time to harvest the crop may be determined by the information processing apparatus on the basis of the elapsed time since the start of cultivation of the crop in the cultivation field. The place of harvest may be selected by the information processing apparatus from among a plurality of places that can be used as places for harvesting the crop.

Still alternatively, the time to remove may be a time to sell the crop cultivated in the cultivation field. In that case, the second place may be a place where the crop of the cultivation field is sold, which will also be referred to as “the sales place”. Thus, the cultivation field can be removed automatically from the first place (e.g. a place suitable for the cultivation of the crop or a place where the crop is harvested) to the second place (i.e. the sales place) in accordance with the time to sell the crop. This can save the worker's effort of going to the first place and performing the operation of harvesting the crop and the effort of transporting the crops from the first place to the second place. Information about the time to sell the crop and information about the sales place may be provided by the user of the vehicle body unit. The time to sell the crop may be determined by the information processing apparatus on the basis of the elapsed time since the start of cultivation of the crop in the cultivation field or the time to harvest the crop. The sales place may be selected by the information processing apparatus from among a plurality of places that can be used as the sales place.

Still alternatively, the time to remove may be a time when an agricultural workshop using the cultivation field is held. In that case, the second place may be a place where the agricultural workshop is held, which will be referred to as “the workshop place”. Thus, the cultivation field can be removed automatically from the first place to the second place (i.e. the workshop place) in accordance with the time when the agricultural workshop is held. This enables the agricultural workshop to be held at a place remote from the first place. This can eliminate the need for the participants of the workshop to go to the first place. Information about the time when the workshop is held and information about the workshop place may be provided by the user of the vehicle body unit (or the cultivation field) or the sponsor of the workshop.

Still alternatively, the time to remove may be a time arbitrarily designated by the user of the vehicle body unit. The second place may be a place arbitrarily designated by the user of the vehicle body unit. Thus, the location of the cultivation field can be changed automatically in accordance with the time to remove and the second place designated by the user of the vehicle body unit.

### Embodiment

In the following, a specific embodiment of the present disclosure will be described with reference to the drawings. It should be understood that dimensions, materials, shapes, relative arrangements, and other features of the component that will be described in connection with the embodiment are not intended to limit the technical scope of the disclosure only to them, unless otherwise stated.

What will be described in the following as an embodiment is a case where the information processing apparatus according to this disclosure is applied to a system that provides a service for managing cultivation fields. This system will also be referred to as the cultivation field management system hereinafter. In this disclosure, the cultivation field refers to a field for cultivating (or growing) a crop as with an agricultural field.

(General Configuration of Cultivation Field Management System)

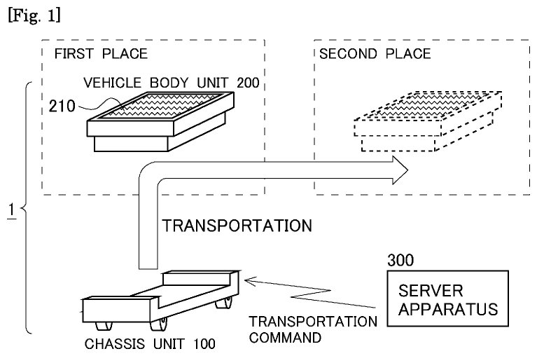

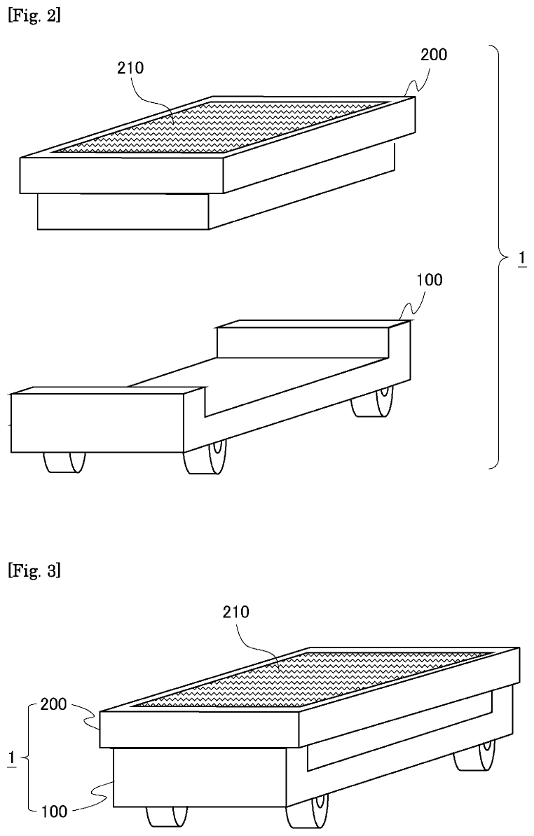

FIG. 1 is a diagram illustrating the general configuration of the cultivation field management system. The cultivation field management system according to this disclosure provides the service of managing cultivation fields using separable vehicles 1. As illustrated in FIG. 1, the cultivation field management system includes a separable vehicle 1 and a server apparatus 300. As illustrated in FIGS. 2 and 3, the separable vehicle 1 includes a chassis unit 100 capable of travelling autonomously by autonomous driving and a vehicle body unit 200 on which a cultivation field 210 is mounted. The chassis unit 100 and the vehicle body unit 200 of the separable vehicle 1 can be coupled to and decoupled from each other. FIG. 2 illustrates the chassis unit 100 and the vehicle body unit 200 in the decoupled (or separated) state. FIG. 3 illustrates the chassis unit 100 and the vehicle body unit 200 in the coupled state. The chassis units 100 and the vehicle body units 200 of the separable vehicles 1 are managed by the server apparatus 300. The cultivation field 210 used in the system of this embodiment is an agricultural field for cultivating crops, garden plants, or other plants.

The vehicle body unit 200 in the system according to the embodiment is set at a desired place to cultivate a crop in the cultivation field 210. For this purpose, the vehicle body unit 200 is laid at a specific place with the chassis unit 100 decoupled. The reason why the vehicle body unit 200 is left separated from the chassis unit 100 is to allow efficient use of the chassis unit 100 and to reduce the cost of equipment. The place where the vehicle body unit 200 is set is a place that is suitable for the cultivation of the crop in the cultivation field 210. This place may be changed when necessary.

If the place where the vehicle body unit 200 is set is fixed, changes in the environment around that place may adversely affect the cultivation of the crop. If a change in the environment around that place is expected to occur, it may be necessary for a worker (e.g. the user of the vehicle body unit 200 or the user of the cultivation field 210) to go to the cultivation field 210 to take some action. To address this issue, the system of this embodiment is configured to change the place where the vehicle body unit 200 is set at the time when the environment around the place where the vehicle body unit 200 is set changes into an environment unsuitable for the cultivation of the crop, which is the “time to remove”. This time to remove may be either a time when the environment around the place where the vehicle body unit 200 is set actually changes into an environment unsuitable for the cultivation of the crop or a time when the environment around the place where the vehicle body unit 200 is set is expected to change into an environment unsuitable for the cultivation of the crop.

The operation of changing the place where the vehicle body unit 200 is set is carried out by a chassis unit 100 that operates under the management of the server apparatus 300. Specifically, the server apparatus 300 sends to the chassis unit 100 a command to transport the vehicle body unit 200 from the place where the vehicle body unit 200 is presently set (i.e. the first place) to another place (i.e. the second place), as illustrated in FIG. 1. This command will be hereinafter referred to as the “transportation command”. Then, the chassis unit 100 operates pursuant to the transportation command sent from the server apparatus 300 to transport the vehicle body unit 200 from the first place to the second place.

(Hardware Configuration of Cultivation Field Management System)

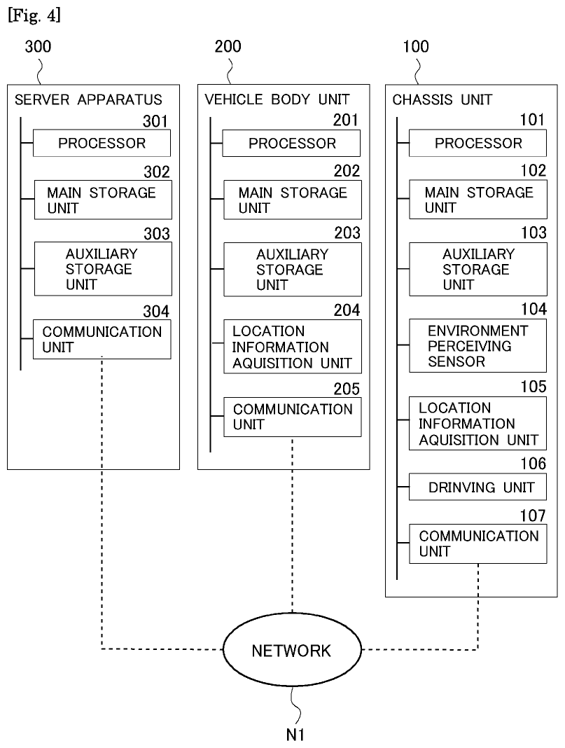

The components of the cultivation field management system will now be described specifically. FIG. 4 is a diagram illustrating the hardware configurations of the chassis unit 100, the vehicle body unit 200, and the server apparatus 300 shown in FIG. 1. While FIG. 4 illustrates only one chassis unit 100 and only one vehicle body unit 200, the number of chassis units 100 and the number of vehicle body units 200 under the management of the server apparatus 300 may be two or more.

The chassis unit 100 is a mobile unit capable of travelling on the road autonomously pursuant to an operation command. The chassis unit 100 has a processor 101, a main storage unit 102, an auxiliary storage unit 103, an environment perceiving sensor 104, a location information acquisition unit 105, a driving unit 106, and a communication unit 107. The chassis unit 100 used in the system according to the embodiment is an electric car that is driven by an electric motor. The motor of the chassis unit 100 is not limited to the electric motor, but it may be an internal combustion engine or a hybrid system of an internal combustion engine and an electric motor.

The processor 101 may be, for example, a CPU (Central Processing Unit) or a DSP (Digital Signal Processor). The processor 101 controls the chassis unit 100 and executes computation of various information processing in order to control the chassis unit 101. The main storage unit 102 may include a RAM (Random Access Memory), a ROM (Read Only Memory) and/or the like. The auxiliary storage unit 103 may include, for example, an EPROM (Erasable Programmable ROM) or a hard disk drive (HDD). The auxiliary storage unit 103 may include a removable medium, in other words, a portable recording medium. Examples of the removable medium include a USB (Universal Serial Bus) memory and disc recording media, such as a CD (Compact Disc) and a DVD (Digital Versatile Disc).

What is stored in the auxiliary storage unit 103 includes various programs, various data, and various tables, which can be written into and read out from the auxiliary storage unit 103. The auxiliary storage unit 103 stores an operating system (OS), various programs, and various tables. All or a portion of the aforementioned information and data stored in the auxiliary storage unit 103 may be stored in the main storage unit 102 instead. Likewise, all or a portion of information and data stored in the main storage unit 102 may be stored in the auxiliary storage unit 103 instead.

The environment perceiving sensor 104 is means for sensing the environment of the vehicle, which typically includes a stereo camera, a laser scanner, a LIDAR, a radar, or the like. Information acquired by the environment perceiving sensor 104 is passed to the processor 101.

The location information acquisition unit 105 is a device for acquiring information about the present location of the chassis unit 100. The location information acquisition unit 105 typically includes a GPS receiver. The location information acquisition unit 105 acquires information about the present location of the chassis unit 100 repeatedly at predetermined intervals. The location information acquired by the location information acquisition unit 105 is sent to the server apparatus 300 through the communication unit 107, which will be described later. Thus, location information of the chassis unit 100 is sent from the chassis unit 100 to the server apparatus 300 repeatedly at predetermined intervals. In consequence, the server apparatus 300 can recognize the present location of each chassis unit 100.

The driving unit 106 is a device that drives the chassis unit 100. The driving unit includes, for example, an electronic motor, a braking device, and a steering device.

The communication unit 107 is a device that connects the chassis unit 100 to a network N1. The communication unit 107 connects itself with the network N1 using mobile communications, such as 5G (5th Generation) mobile communications or LTE (Long Term Evolution) mobile communications. Alternatively, the communication unit 107 may connect itself with the network N1 using narrow-band communications, such as DSRC (Dedicated Short Range Communications), or Wi-Fi (registered trademark). Thus, the communication unit 107 can communicate with other devices such as the vehicle body unit 200 and the server apparatus 300 via the network N1. For example, the communication unit 107 sends the present location information acquired by the location information acquisition unit 105 and other information to the server apparatus 300 via the network N1. The network N1 may be, for example, a WAN (Wide Area Network), which may be a global public communication network such as the Internet, or other communication network.

The hardware configuration of the chassis unit 100 is not limited to that illustrated in FIG. 4, but some components may be eliminated, replaced, or added. For example, the chassis unit 100 may be provided with an apparatus used to perform the operation of coupling it with and/or decoupling it from the vehicle body unit 200. Examples of such an apparatus include a heavy machine equipped with a lift or a crane and an electromagnet device. Various processing executed by the chassis unit 100 may be executed by either hardware or software.

As described above, the vehicle body unit 200 is a unit on which the cultivation field 210 is mounted. The vehicle body unit 200 has a processor 201, a main storage unit 202, an auxiliary storage unit 203, a location information acquisition unit 204, and a communication unit 205. The processor 201, the main storage unit 202, the auxiliary storage unit 203, the location information acquisition unit 204, and the communication unit 205 are similar to their corresponding components of the chassis unit 100 and therefore will not be described further.

The hardware configuration of the vehicle body unit 200 is not limited to that illustrated in FIG. 4, but some components may be eliminated, replaced, or added. Various processing executed by the vehicle body unit 200 may be executed by either hardware or software.

The server apparatus 300 is an apparatus that manages the chassis unit 100 and the vehicle body unit 200. The server apparatus 300 constitutes the information processing apparatus according to the disclosure. The server apparatus 300 has a configuration as an ordinary computer. The server apparatus 300 has a processor 301, a main storage unit 302, an auxiliary storage unit 303, and a communication unit 304. The processor 301, the main storage unit 302, the auxiliary storage unit 303, and the communication unit 304 are interconnected by busses. The processor 301, the main storage unit 302, and the auxiliary storage unit 303 are similar to their corresponding components of the chassis unit 100 and therefore will not be described further. The communication unit 304 performs communication of information between the server apparatus 300 and external devices. The communication unit 304 may include, for example, a LAN (Local Area Network) interface board or a wireless communication circuit for wireless communication. The LAN interface board or the wireless communication circuit is connected to the network N1. The hardware configuration of the server apparatus 300 is not limited to that illustrated in FIG. 4, but some components may be eliminated, replaced, or added. Various processing executed by the server apparatus 300 may be executed by either hardware or software.

(Functional Configuration of Chassis Unit)

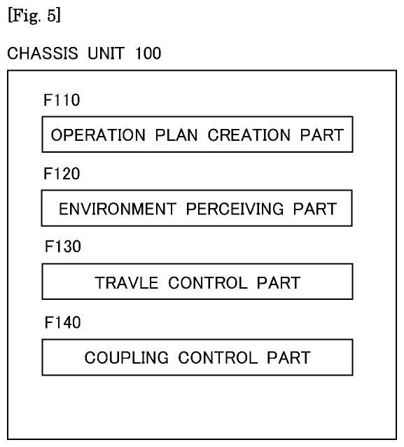

The functional configuration of the chassis unit 100 will now be described with reference to FIG. 5. As illustrated in FIG. 5, the chassis unit 100 according to this embodiment includes, as functional components, an operation plan creation part F110, an environment perceiving part F120, a travel control part F130, and a coupling control part F140. The chassis unit 100 implements these functional components by executing programs stored in the main storage unit 102 or the auxiliary storage unit 103 by the processor 101. One or some of the operation plan creation part F110, the environment perceiving part F120, the travel control part F130, and the coupling control part F140 may be implemented entirely or partly by a hardware circuit(s). One or some of the above functional components or a part of the processing of them may be implemented by another computer(s) connected to the network N1. For example, the processing executed as the operation plan creation part F110, the processing executed as the environment perceiving part F120, the processing executed as the travel control part F130, and the processing executed as the coupling control part F140 may be executed by different computers.

The operation plan creation part F110 is configured to create an operation plan of the chassis unit 100 on the basis of an operation command sent from the server apparatus 300. The operation plan is data specifying a route along which the chassis unit 100 is to travel and an operation(s) that the chassis unit 100 is to perform in a part or the entirety of the route.

Examples of data included in the operation plan are as follows.

(1) Data that Specifies a Route Along which the Chassis Unit 100 is Planned to Travel (Planned Travel Route) by a Set of Road Links

The planned travel route mentioned above may be created, for example, by the operation plan creation part F110 based on the command sent from the server apparatus 300 using map data stored in the auxiliary storage unit 103 or other storage means. Alternatively, the planned travel route may be created using an external service or supplied by the server apparatus 300.

(2) Data that Specifies an Operation(s) to be Performed by the Chassis Unit 100 at a Certain Location(s) in the Planned Travel Route

Examples of the aforementioned certain location include a location at which the chassis unit 100 and the vehicle body unit 200 are decoupled from or coupled to each other and a location to which the vehicle body unit 200 is to be removed. An example of the operation to be performed by the chassis unit 100 at a certain location includes, but is not limited to, decoupling/coupling the chassis unit 100 from/to the vehicle body unit 200.

The environment perceiving part F120 is configured to perceive the environment around the chassis unit 100 using data acquired by the environment perceiving sensor 104. Examples of what is perceived by the environment perceiving part F120 include, but are not limited to, the number and the position of lanes, the number and the position of vehicles present around the chassis unit 100, the number and the position of obstacles present around the chassis unit 100, the structure of the road, and road signs. What is perceived by the environment perceiving part F120 may include anything that is useful for autonomous traveling of the chassis unit 100. The environment perceiving part F120 may be configured to perform tracking of a perceived object. For example, the environment perceiving part F120 may be configured to calculate the relative speed of the perceived object from the difference between the coordinates of the object determined in a previous step and the present coordinates of it.

The travel control part F130 is configured to control the travel of the chassis unit 100 on the basis of the operation plan created by the operation plan creation part F110, environment data created by the environment perceiving part F120, and the location information of the chassis unit 100 acquired by the location information acquisition part 105. For example, the travel control part F130 causes the chassis unit 100 to travel along the planned travel route created by the operation plan creation part F110. In doing so, the travel control part F130 causes the chassis unit 100 to travel so that obstacles will not enter a predetermined safety zone around the chassis unit 100. A known method may be employed to cause the chassis unit 100 to travel autonomously. Moreover, the travel control part F130 has the function of controlling the travel of the chassis unit 100 pursuant to the command sent from the server apparatus 300.

The coupling control part F140 is configured to control coupling and decoupling of the chassis unit 100 and the vehicle body unit 200 to and from each other. In the case where the operations of coupling and decoupling the chassis unit 100 and the vehicle body unit 200 are carried out by an external apparatus, the coupling control part F140 controls this external apparatus by wireless communication or the like to carry out the operations of coupling and decoupling the chassis unit 100 and the vehicle body unit 200. In the case where the chassis unit 100 is provided with an apparatus that carries out the operations of coupling and decoupling the chassis unit 100 and the vehicle body unit 200, the coupling control part F140 controls this apparatus to carry out the operations of coupling and decoupling the chassis unit 100 and the vehicle body unit 200.

(Functional Configuration of Server Apparatus)

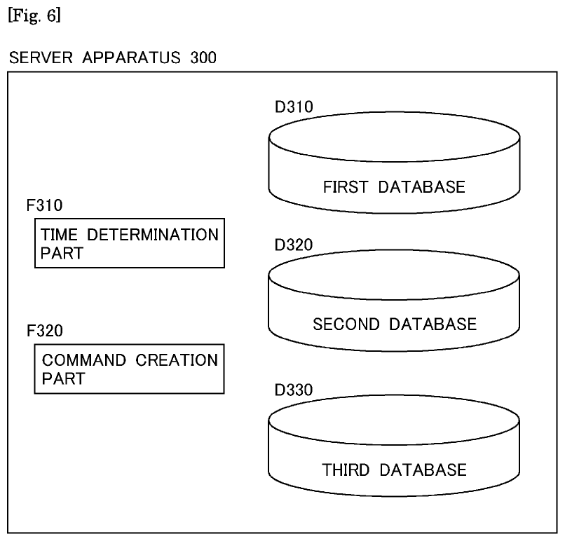

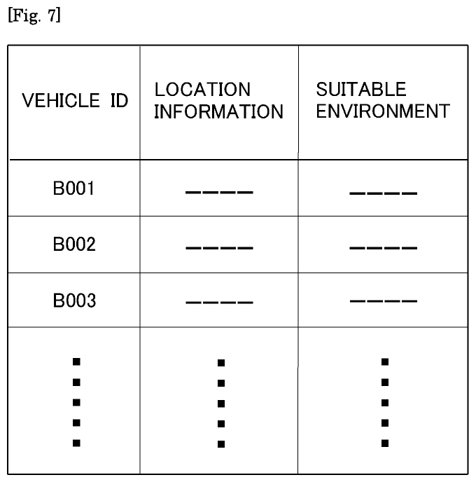

The functional configuration of the server apparatus 300 will be described next with reference to FIG. 6. As illustrated in FIG. 6, the server apparatus 300 in the system according to this embodiment includes, as functional components, a time determination part F310, a command creation part F320, a first database D310, a second database D320, and a third database D330. The server apparatus 300 implements the time determination part F310 and the command creation part F320 by executing programs stored in the main storage unit 302 or the auxiliary storage unit 303 by the processor 301. The time determination part F310 and/or the command creation part F320 may be implemented entirely or partly by a hardware circuit(s). The time determination part F310 or the command creation part F320 or a part of the processing of them may be implemented by another computer(s) connected to the network N1. For example, the processing executed as the time determination part F310 and the processing executed as the command creation part F320 may be executed by different computers.

The first database D310, the second database D320, and the third database D330 are created by a database management system program (DBMS program) executed by the processor 301. Specifically, the first database D310, the second database D320, and the third database D330 are created by managing data stored in the auxiliary storage unit 303 by the DBMS program. The first database D310, the second database D320, and the third database D330 are, for example, relational databases.

What is stored in the first database D310 is information about the vehicle body units 200 with crops under cultivation in their cultivation fields 210. An exemplary structure of the information stored in the first database D310 will be described with reference to FIG. 7. FIG. 7 illustrates the structure of a table stored in the first database D310. The structure of the table stored in the first database D310 (which will also be referred to as the “vehicle body information table” hereinafter) is not limited to that illustrated in FIG. 7, but some fields may be added, changed, or removed fitly.

The vehicle body information table in FIG. 7 has the fields of vehicle body ID, location information, and suitable environment. What is stored in the vehicle body ID field is information identifying each vehicle body unit 200 with the crop under cultivation (vehicle body ID). What is stored in the location information field is information indicating the location at which each vehicle body unit 200 with the crop under cultivation is laid, in other words the location at which each cultivation field 210 is set. The information stored in the location information field may be the address of the place where the vehicle body unit 200 is laid or information indicating the coordinates on a map (or longitude and latitude) of the place where the vehicle body unit 200 is laid. What is stored in the suitable environment field is information about an environment suitable for the cultivation of the crop in the cultivation field 210 of each vehicle body unit 200. This information will also be referred to as the “suitable environment information” hereinafter. An example of the suitable environment information includes information about the weather (e.g. weather elements such as temperature, precipitation, cloud amount, wind direction, and atmospheric pressure) that is suitable for the cultivation of the crop.

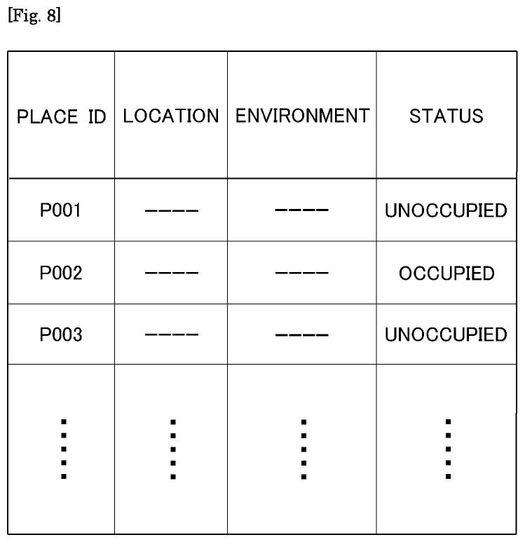

What is stored in the second database D320 is information about places where a vehicle body unit 200 can be laid, which will also be referred to as “potential places” hereinafter. An exemplary structure of the information stored in the second database D320 will be described with reference to FIG. 8. FIG. 8 illustrates the structure of a table stored in the second database D320. The structure of the table stored in the second database D320 (which will also be referred to as the “potential place information table” hereinafter) is not limited to that illustrated in FIG. 8, but some fields may be added, changed, or removed fitly.

The potential place information table in FIG. 8 has the fields of place ID, location, environment, and status. What is stored in the place ID field is information identifying each potential place (place ID). What is stored in the location field is information indicating the location of each potential place. The information stored in the location field may be the address of each potential place or information indicating the coordinates on a map (or longitude and latitude) of each potential place. What is stored in the environment field is information about the environment around each potential place. For example, what is stored in the environment field may be information about the weather (e.g. weather elements such as temperature, precipitation, cloud amount, wind direction, and atmospheric pressure) at each potential place and information about the occurrence and absence of a disaster. The information stored in the environment field may be either information about the environment around each potential place at the present time or information about the environment around each potential place in the future. What is stored in the status field is information about the vacancy (or occupation) of each potential place. For example, if a potential place has a room for laying a vehicle body unit 200, the information “unoccupied” is stored in the status field for that place. If a potential place has no room for laying a vehicle body unit 200, the information “occupied” is stored in the status field for that place.

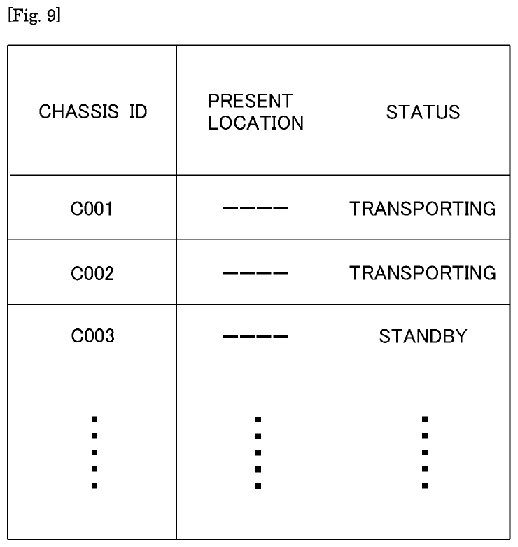

What is stored in the third database D330 is information about the chassis units 100. An exemplary structure of the information stored in the third database D330 will be described with reference to FIG. 9. FIG. 9 illustrates the structure of a table stored in the third database D330. The structure of the table stored in the third database D330 (which will also be referred to as the “chassis information table” hereinafter) is not limited to that illustrated in FIG. 9, but some fields may be added, changed, or removed fitly.

The chassis information table in FIG. 9 has the fields of chassis ID, present location, and status. What is stored in the chassis ID field is information identifying each chassis unit 100 (chassis ID). What is stored in the present location field is information indicating the present location of the chassis unit 100. The information stored in the present location field may be the address of the place where each chassis unit 100 is presently located or information indicating the coordinates on a map (or longitude and latitude) of the place where the chassis unit 100 is presently located. What is stored in the status field is information indicating the status of each chassis unit 100. For example, while the chassis unit 100 is transporting a vehicle body unit 200, the information “transporting” is stored in the status field. While the chassis unit 100 is not coupled with any vehicle body unit 200 but on standby at a certain service site, the information “standby” is stored in the status field.

The time determination part F310 determines the time to remove a vehicle body unit 200. The time to remove is the time to change the place at which the vehicle body unit 200 with a crop under cultivation is laid. In this embodiment, the time to remove is the time when the environment around the place (first place) where the vehicle body unit 200 is presently laid changes into an environment that is not suitable for the cultivation of the crop. Alternatively, the time to remove in this embodiment may be the time when the environment around the first place is expected to change into an environment that is not suitable for the cultivation of the crop.

To determine the time to remove, the time determination part F310 firstly accesses the first database D310 to read out the information stored in the location information field of the vehicle body information table, namely the location information of the first place. Then, the time determination part F310 obtains information about the weather and the occurrence and absence of a disaster around the first place. The information about the weather and the occurrence and absence of a disaster may be obtained using an external service, such as a weather forecast service or a disaster information service provided on the Internet. Then, the time determination part F310 determines whether a disaster is occurring around the first place on the basis of the information about the occurrence and absence of a disaster it has obtained. If a disaster is occurring around the first place, it is determined that the time to remove the vehicle body unit 200 has come. On the other hand, if a disaster is not occurring around the first place, the time determination part F310 compares the information about the weather it has obtained with the suitable environment information stored in the suitable environment field of the vehicle body information table. If the obtained information about the weather does not match the suitable environment information, it is determined that the time to remove the vehicle body unit 200 has come. If a vehicle body unit 200 for which the time to remove has come is detected, the time determination part F310 passes the location information of the first place and the suitable environment information for the cultivation field 210 mounted on the vehicle body unit 200 to the command creation part F320.

The above processing by the time determination part F310 is executed for every vehicle body information table stored in the first database D310 repeatedly at predetermined intervals.

The command creation part F320 creates a command for transporting a vehicle body unit 200 for which the time to remove has come from the first place to another place (second place). This command will be referred to as the “transportation command”. In the system of this embodiment, the vehicle body unit 200 is transported automatically by a chassis unit 100. To this end, the transportation command includes the following first to fourth commands:
first command: a command to cause the chassis unit 100 to travel to the first place
second command: a command to couple the chassis unit 100 to the vehicle body unit 200 at the first place
third command: a command to cause the chassis unit 100 to travel from the first place to the second place
fourth command: a command to decouple the chassis unit 100 from the vehicle body unit 200 at the second place.

The transportation command created by the command creation part F320 is sent to the chassis unit 100 through the communication unit 304. The second place designated by the transportation command is determined based on the information stored in the second database D320. For example, the command creation part F320 extracts the potential place information tables that store the information “unoccupied” in their status fields from among the potential place information tables stored in the second database D320. Then, the command creation part F320 selects the potential place information tables that store information indicating that a disaster is not occurring and weather information that matches the suitable environment information in their environment fields from among the extracted potential place information tables. If there are a plurality of potential place information tables thus selected, the command creation part F320 may select the potential place information table of which the location indicated by the information stored in the location field is closest to the first place. The potential place associated with the potential place information table thus selected is selected as the second place.

The chassis unit 100 to which the transportation command is to be sent is determined based on the information stored in the third database D330. For example, the command creation part F320 firstly extracts chassis information tables that store the information “standby” in their status fields from among the chassis information tables stored in the third database D330. Then, the command creation part F320 selects the chassis information table of which the present location indicated by the information stored in the present location field is closest to the first place from among the extracted chassis information tables. Thus, the chassis unit 100 associated with the chassis information table thus selected is selected as the chassis unit to which the transportation command is to be sent.

(Process Performed by the Server Apparatus)

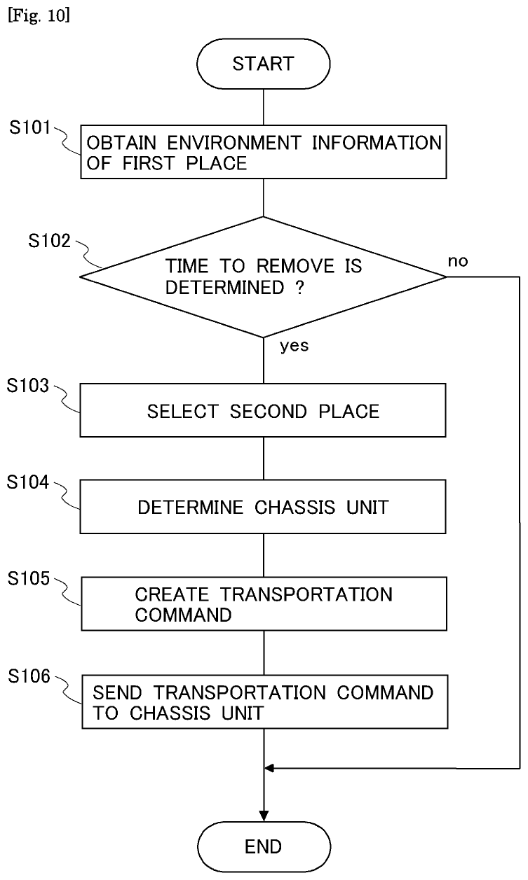

A process performed by the server apparatus 300 in the system according to the embodiment will be described with reference to FIG. 10. FIG. 10 is a flow chart of the process performed by the server apparatus 300 repeatedly at predetermined intervals.

In the process according to the flow chart of FIG. 10, the time determination part F310 of the server apparatus 300 obtains environment information of the place (first place) where the vehicle body unit 200 with the crop under cultivation is laid (step S101). Specifically, the time determination part F310 accesses the vehicle body information table in the first database D310 to obtain the location information (i.e. the location information of the first place) stored in the location information table. Then, the time determination part F310 obtains information about the weather and the occurrence and absence of a disaster around the first place by, for example, using an external service.

The time determination unit F310 determines whether the time to remove has come based on the environment information obtained in step S101 (S102). In other words, the time determination part F310 determines whether a vehicle body unit 200 for which the time to remove has come is detected. Specifically, the time determination part F310 firstly determines whether a disaster is occurring around the first place on the basis of the environment information obtained in step S101. If a disaster is occurring around the first place, it is determined that the time to remove the vehicle body unit 200 laid at the first place has come. Thus, it is determined that the time to remove has come (an affirmative answer in step S102). If a disaster is not occurring around the first place, the time determination part F310 reads out the suitable environment information stored in the suitable environment field of the vehicle body information table. If the environment information obtained in step S101 does not match the suitable environment information, the time determination part F310 determines that the time to remove the vehicle body unit 200 laid at the first place has come. In this case also, an affirmative determination is made in step S102. On the other hand, if the environment information obtained in step S101 matches the suitable environment information, it is determined that the time to remove the vehicle body unit 200 laid at the first place has not come. In consequence, a negative determination is made in step S102. If a negative determination is made in step S102, the processing routine according to the flow chart of FIG. 10 is ended. If an affirmative determination is made in Step S102, the time determination part F310 passes the information about the present location of the vehicle body unit 200 for which the time to remove has come (i.e. the first place) and the suitable environment information for the cultivation field 210 mounted on the vehicle body unit 200 to the command creation part F320.

The command creation part F320 determines a place (second place) to which the vehicle body unit 200 for which the time to removal has come is to be transported (step S103). Specifically, the command creation part F320 accesses the second database D320 to extract the potential place information tables that store the information “unoccupied” in their status fields from among the potential place information tables stored in the second database D320. Then, the command creation part F320 selects the potential place information tables that store information indicating that a disaster is not occurring and weather information that matches the suitable environment information in their environment fields from among the extracted potential place information tables. If there are a plurality of potential place information tables thus selected, the command creation part F320 selects the potential place information table of which the location indicated by the information stored in the location field is closest to the first place. Then, the command creation part F320 determines or selects the potential place associated with the potential place information table thus selected as the second place.

The command creation part F320 determines the chassis unit 100 to be employed to transport the vehicle body unit 200 (step S104). Specifically, the command creation part F320 accesses the third database to extract the chassis information tables that store the information “standby” in their status fields. Then, the command creation part F320 selects the chassis information table of which the present location indicated by the information stored in the present location field is closest to the first place from among the extracted chassis information tables. Thus, the command creation part F320 selects the chassis unit 100 associated with the chassis information table thus selected as the chassis unit to be employed to transport the vehicle body unit 200.

The command creation part F320 creates a transportation command based on the location of the first place, the location of the second place determined in step S103, and the present location of the chassis unit 100 selected in step S104 (step S105). In other words, the command creation part F320 creates a transportation command including the first to fourth commands mentioned above. The transportation command thus created is sent to the chassis unit 100 selected in step S104 through the communication unit 304 (step S106).

After the chassis unit 100 receives the transportation command, the operation plan creation part F110 of the chassis unit 100 creates an operation plan based on the transportation command. As described before, the operation plan includes data that specifies a planned travel route of the chassis unit 100 by a set of road links and data that specifies operations to be performed by the chassis unit 100 at certain locations in the planned travel route. The planned travel route is a route from the present location of the chassis unit 100 to the second place via the first place. The aforementioned certain locations are the first place and the second place. The operation to be performed by the chassis unit 100 at the first place is to couple the chassis unit 100 to the vehicle body unit 200, and the operation to be performed by the chassis unit 100 at the second place is to decouple the chassis unit 100 from the vehicle body unit 200.

After the operation plan is created as above, the travel control part F130 of the chassis unit 100 starts to control the travel of the chassis unit 100. Specifically, the travel control part F130 controls the travel of the chassis unit 100 by controlling the driving unit 106 on the basis of the operation plan, the environment data created by the environment perceiving part F120, and the location information acquired by the location information acquisition unit 105. Thus, the chassis unit 100 can travel autonomously from its present location to the first place by autonomous driving. After the chassis unit 100 arrives at the first place, the coupling control part F140 of the chassis unit 100 controls an external apparatus or an apparatus provided on the chassis unit 100 to couple the chassis unit 100 to the vehicle body unit 200. After the completion of the operation of coupling the chassis unit 100 to the vehicle body unit 200, the travel control part F130 of the chassis unit 100 causes the chassis unit 100 to restart to travel. Specifically, the travel control part F130 controls the driving unit 106 on the basis of the operation plan, the environment data, and the location information to cause the chassis unit 100 to travel autonomously from the first place to the second place by autonomous driving. In this way, the chassis unit 100 can transport the vehicle body unit 200 from the first place to the second place. After the chassis unit 100 arrives at the second place, the coupling control part F140 causes the chassis unit 100 to be decoupled from the vehicle body unit 200. Thus, the vehicle body unit 200 is laid at the second place. Thereafter, the chassis unit 100 may either return to its previous location by autonomous driving or operate pursuant to another transportation command sent from the server apparatus 300.

As above, the chassis unit 100 transports the vehicle body unit 200 automatically from the first place to the second place. Thus, the environment around the cultivation filed 210 can continuously be suitable for the cultivation of the crop. This prevents the cultivation of the crop from being adversely affected by changes in the environment. Moreover, this can save the user's effort of going to the first place to take countermeasures against changes in the environment.

As above, the cultivation field management system according to this embodiment can perform management of the cultivation field 210 efficiently.

<First Modification>

It is necessary to harvest the crop cultivated in the cultivation field 210 at an appropriate time. It takes time and effort for the user to go to the place of the cultivation field 210 and harvest the crop there.

In a system according to a modification, the time determination part F310 may determine the time to remove as a time to harvest the crop in the cultivation field 210. In this case, the time determination part F310 may execute the processing of determining the time to harvest the crop in the cultivation field 210 in place of the processing of step S101 in the process according to the flow chart of FIG. 10. The time to harvest the crop may be designated by the user of the vehicle body unit 200. Alternatively, the time to harvest the crop may be determined by the time determination part F310 on the basis of the elapsed time since the start of cultivation of the crop in the cultivation field 210 and/or other factors. Instead of the processing of step S102 in the process according to the flow chart of FIG. 10, the time determination part F310 may determine whether a vehicle body unit 200 for which the time to harvest the crop has come is detected. Moreover, instead of the processing of step S103 in the process according to the flow chart of FIG. 10, the command creation part F320 may execute the processing of determining a place where the operation of harvesting the crop is to be performed (place of harvest) as the second place. The place of harvest may be designated by the user of the vehicle body unit 200. Alternatively, the command creation part F320 may select a place among a plurality of places that can be used as the place of harvest. Specifically, for example, the command creation part F320 may pick up the unoccupied places among the aforementioned plurality of places and select as the place of harvest the place to which the user of the vehicle body unit 200 can go most conveniently among the picked-up places.

The system of this modification can reduce the time and effort of the user when harvesting crop in the cultivation field 210. This makes it possible to harvest the crop efficiently. After the crop is harvested, the vehicle body unit 200 may be transported by the chassis unit 100 to another place, where another crop may be planted. This can reduce the time and effort for the user to travel to plant the crop.

<Second Modification>

It may be necessary to sell the crop cultivated in the cultivation field 210 at an appropriate time. It can be troublesome for the user to travel to the place of the cultivation field 210 to harvest the crop and/or transport the harvested crop to a place where the crop is to be sold.

In a system according to a modification, the time determination part F310 may determine the time to remove as a time to sell the crop cultivated in the cultivation field 210. In this case, the time determination part F310 may execute the processing of determining the time to sell the crop cultivated in the cultivation field 210 in place of the processing of step S101 in the process according to the flow chart of FIG. 10. The time to sell the crop may be designated by the user of the vehicle body unit 200. Alternatively, the time to sell the crop may be determined by the time determination part F310 on the basis of the elapsed time since the start of cultivation of the crop in the cultivation field 210 or the time to harvest the crop in the cultivation field 210. Instead of the processing of step S102 in the process according to the flow chart of FIG. 10, the time determination part F310 may determine whether a vehicle body unit 200 for which the time to sell the crop has come is detected. Moreover, instead of the processing of step S103 in the process according to the flow chart of FIG. 10, the command creation part F320 may execute the processing of determining a place where the crop is to be sold as the second place. The place where the crop is to be sold (sales place) may be designated by the user of the vehicle body unit 200. Alternatively, the command creation part F320 may select a place among a plurality of places that can be used as the sales place. Specifically, for example, the command creation part F320 may pick up the unoccupied places among the aforementioned plurality of places and select as the sales place the place to which the user of the vehicle body unit 200 can go most conveniently among the picked-up places.

The system of this modification can save the user's time and effort of travelling and transporting the crop when selling the crop in the cultivation field 210. This makes it possible to sell the crop efficiently.

<Third Modification>

The cultivation field 210 may be used in an agricultural workshop. In such cases, it can take time and effort for participants to go to the workshop, if their travel distance is large.

In a system according to a modification, the time determination part F310 may determine the time to remove as a time when an agricultural workshop using the cultivation field 210 is held. In this case, the time determination part F310 may execute the processing of determining the time to hold the agricultural workshop in place of the processing of step S101 in the process according to the flow chart of FIG. 10. The time to hold the agricultural workshop may be designated by the user of the vehicle body unit 200 or the sponsor of the agricultural workshop. Instead of the processing of step S102 in the process according to the flow chart of FIG. 10, the time determination part F310 may determine whether a vehicle body unit 200 for which the time to hold the agricultural workshop has come is detected. Moreover, instead of the processing of step S103 in the process according to the flow chart of FIG. 10, the command creation part F320 may execute the processing of determining a place where the workshop is to be held as the second place. The place where the workshop is to be held may be designated by the user of the vehicle body unit 200 or the sponsor of the workshop.

As above, when an agricultural workshop using the cultivation field 210 is to be held, the system of this modification allows the agricultural workshop to be held at a place remote from the first place. This allows the workshop to be held at a place to which the participants can go to easily. This can reduce the time and effort for the participants to go to the workshop.

### Fourth Embodiment

The time to remove and the second place may be determined based on a request by the user of the vehicle body unit 200. In that case, the server apparatus 300 may receive information (or a removal request) including information about the time when the vehicle body unit 200 is to be removed from the first place (or the date and time of the removal) and information about the place to which the vehicle body unit 200 is to be removed. This removal request may be sent from a terminal used by the user to the server apparatus 300 through the network N1. The time determination part F310 of the server apparatus 300 may determine the time to remove the second vehicle 200 as the aforementioned date and time of removal. The command creation part F320 of the server apparatus 300 may set the destination of the removal designated by the user as the second place.

The system of this modification can transport the vehicle body unit 200 to a place designated by the user at a time designated by the user. This improves the convenience of the user.

<Fifth Modification>

While in the systems according to the embodiment and the first to fourth modifications, the processing of determining the time to remove and the processing of creating a transportation command are executed by the server apparatus 300, they may be executed by the chassis unit 100 instead. In other words, the processing executed by the time determination part F310 and the command creation part F320 may be executed by the chassis unit 100. In that case, the chassis unit 100 may implement the functions same as the time determination part F310 and the command creation part F320 by executing a program(s) stored in the main storage unit 102 or the auxiliary storage unit 103 by the processor 101.

<Others>

The above embodiment and modifications have been described only by way of example. Changes can be made to the above embodiment and modifications without departing from the essence of the present disclosure. For examples, features of the above embodiment and modifications may be employed in any possible combination.

The processing and means that have been described in this disclosure may be employed in any combination so long as it is technically feasible to do so. One, some, or all of the processes that have been described as processes performed by a single apparatus may be performed by a plurality of apparatuses in a distributed manner. One, some, or all of the processes that have been described as processes performed by a plurality of apparatuses may be performed by a single apparatus. The hardware configuration employed to implement various functions in a computer system may be modified flexibly.

The technology according to this disclosure can be carried out by supplying a computer program(s) (or information processing program(s)) that implements the functions described in the above description of the embodiment to a computer to let one or more processors of the computer read and execute the program(s). Such a computer program(s) may be supplied to the computer by a computer-readable, non-transitory storage medium that can be connected to a system bus of the computer or through a network. The computer-readable, non-transitory storage medium refers to a recording medium that can store information, such as data and programs, electrically, magnetically, optically, mechanically, or chemically in such a way as to allow the computer or the like to read the stored information. Examples of such a storage medium include any type of disc medium including a magnetic disc, such as a floppy disc (registered trademark) and a hard disk drive (HDD), and an optical disc, such as a CD-ROM, a DVD, and a Blu-ray disc. Further examples of the storage medium include a read-only memory (ROM), a random access memory (RAM), an EPROM, an EEPROM, a magnetic card, a flash memory, an optical card, and a solid state drive (SSD).

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An information processing apparatus comprising a controller equipped with at least one processor,
the controller configured to execute the processing of:
when a vehicle body unit on which a cultivation field for cultivating a crop is mounted is laid at a first place, determining a time to remove defined as a time to remove the vehicle body unit from the first place to a second place other than the first place; and
sending a transportation command to a chassis unit in accordance with the time to remove, the chassis unit being configured to be capable of travelling autonomously and being coupled to and decoupled from any vehicle body unit, and the transportation command being a command to transport the vehicle body unit from the first place to the second place.

2. An information processing apparatus according to claim 1, wherein the transportation command includes:
a command to cause the chassis unit to travel to the first place;
a command to couple the chassis unit to the vehicle body unit at the first place;
a command to cause the chassis unit to travel from the first place to the second place; and
a command to decouple the chassis unit from the vehicle body unit at the second place.

3. An information processing apparatus according to claim 1, wherein the time to remove is a time when the environment around the first place changes to an environment that is not suitable for the cultivation of the crop in the cultivation field, and the second place is a place having an environment suitable for the cultivation of the crop in the cultivation field.

4. An information processing apparatus according to claim 3, wherein the environment around the first place comprises the weather at the first place.

5. An information processing apparatus according to claim 3, wherein the environment around the first place comprises the occurrence and absence of a disaster around the first place.

6. An information processing apparatus according to claim 1, wherein the time to remove is a time to harvest the crop in the cultivation field, and the second place is a place where the operation of harvesting the crop in the cultivation field is to be performed.

7. An information processing apparatus according to claim 1, wherein the time to remove is a time to sell the crop cultivated in the cultivation field, and the second place is a place where the crop cultivated in the cultivation field is to be sold.

8. An information processing apparatus according to claim 1, wherein the time to remove is a time when an agricultural workshop using the cultivation field is to be held, and the second place is a place where the cultivation field is to be held.

9. An information processing apparatus according to claim 1, wherein the time to remove is a time designated by a user of the vehicle body unit, and the second place is a place designated by the user of the vehicle body unit.

10. An information processing method comprising the following steps of processing executed by a computer:
when a vehicle body unit on which a cultivation field for cultivating a crop is mounted is laid at a first place, determining a time to remove defined as a time to remove the vehicle body unit from the first place to a second place other than the first place; and
sending a transportation command to a chassis unit in accordance with the time to remove, the chassis unit being configured to be capable of travelling autonomously and being coupled to and decoupled from any vehicle body unit, and the transportation command being a command to transport the vehicle body unit from the first place to the second place.

11. An information processing method according to claim 10, wherein the transportation command includes:
a command to cause the chassis unit to travel to the first place;
a command to couple the chassis unit to the vehicle body unit at the first place;
a command to cause the chassis unit to travel from the first place to the second place; and
a command to decouple the chassis unit from the vehicle body unit at the second place.

12. An information processing method according to claim 10, wherein the time to remove is a time when the environment around the first place changes to an environment that is not suitable for the cultivation of the crop in the cultivation field, and the second place is a place having an environment suitable for the cultivation of the crop in the cultivation field.

13. An information processing method according to claim 12, wherein the environment around the first place comprises the weather at the first place.

14. An information processing method according to claim 12, wherein the environment around the first place comprises the occurrence and absence of a disaster around the first place.

15. An information processing method according to claim 10, wherein the time to remove is a time to harvest the crop in the cultivation field, and the second place is a place where the operation of harvesting the crop in the cultivation field is to be performed.

16. An information processing method according to claim 10, wherein the time to remove is a time to sell the crop cultivated in the cultivation field, and the second place is a place where the crop in the cultivation field is to be sold.

17. An information processing method according to claim 10, wherein the time to remove is a time when an agricultural workshop using the cultivation field is to be held, and the second place is a place where the cultivation field is to be held.

18. An information processing method according to claim 10, wherein the time to remove is a time designated by a user of the vehicle body unit, and the second place is a place designated by the user of the vehicle body unit.

19. A vehicle comprising a controller equipped with at least one processor,
the controller configured to execute the processing of:
when a vehicle body unit on which a cultivation field for cultivating a crop is mounted is laid at a first place, determining a time to remove defined as a time to remove the vehicle body unit from the first place to a second place other than the first place; and
performing the operation of transporting the vehicle body unit from the first place to the second place in accordance with the time to remove.

20. A vehicle according to claim 19, wherein the operation of transporting the vehicle body unit from the first place to the second place includes:
the operation of travelling to the first place;
the operation of coupling the vehicle to the vehicle body unit at the first place;
the operation of travelling from the first place to the second place; and
the operation of decoupling the vehicle from the vehicle body unit at the second place.
